(19) United States
(12) Patent Application Publication
(10) Pub. No.: US 2012/0272926 A1
(43) Pub. Date: Nov. 1, 2012

(54) SHOPPING CART AND WALKING HARNESS

(76) Inventor: ELIZABETH ZACK, Brooklyn, NY (US)

(21) Appl. No.: 13/456,821

(22) Filed: Apr. 26, 2012

Related U.S. Application Data
(60) Provisional application No. 61/479,988, filed on Apr. 28, 2011.

(51) Int. Cl. B60R 22/10; A62B 35/00

(52) U.S. Cl. 119/857; 297/468

(57) ABSTRACT

In accordance with the present invention, there is provided is a shopping cart and walking harness wearable by a child for use in a “walking mode” or a “shopping cart mode.” In the walking mode, a leash may be connected to the harness and the child's parent may hold the leash to remain in contact with the child. The harness may be easily transitioned from the walking mode into the shopping cart mode by disconnecting the leash from the harness and connecting the harness to a shopping cart seat. Thus, the shopping cart and walking harness provides a universal, all-in-one device for use in restraining a child when the child is walking, as well as when the child is in a shopping cart seat. The shopping cart and walking harness advantageously provides a single substitute for conventional child leashes and shopping cart restraints.

### CROSS-REFERENCE TO RELATED APPLICATIONS

This application claims the benefit of U.S. Provisional Application No. 61/479,988, filed Apr. 28, 2011, entitled SHOPPING CART AND WALKING HARNESS.

### STATEMENT RE: FEDERALLY SPONSORED RESEARCH/DEVELOPMENT

Not Applicable

### BACKGROUND OF THE INVENTION

1. Technical Field of the Invention

The present invention relates generally to infant harnesses, and more specifically to an infant harness configured to be transitional between a walking mode for use when a child is walking, and a shopping cart mode to secure an infant within a shopping cart seat.

2. Description of the Related Art

Children tend to be very active. Therefore, there is a heavy burden that falls on parents or other caretakers to keep a constant eye on the child to ensure the child's wellness and safety.

Several products have been developed to assist parents in this endeavor. An exemplary device is a conventional child leash which typically includes one end that attaches to the child and another end that connects to the parent to tether the child to the parent. The leash may wrap around the child's wrist for securing the child leash to the child. The other end of the leash may include a handle or a wrist attachment to connect to the parent. When the child and parent are connected via the leash, the child is secured to the parent, which alleviates the burden of keeping track of the child.

Although such child leashes are useful in connecting the parent and the child, there are several deficiencies associated therewith. One particular deficiency is that the child leashes are generally not appealing to the child. For instance, the wrist attachment may be uncomfortable for the child, or the child may not like the appearance of the device, i.e., in the eyes of the child, the device may be strictly utilitarian and may not have any aesthetic or playful qualities. Thus, the child may not be agreeable to wearing the leash, or the child may try to remove the leash, which would thus defeat the overall purpose of the device. Given a child's reluctance to wear the leash, parents may be more likely to completely forego using the devices.

Another deficiency associated with conventional child leashes is that they are generally not configured to provide use in multiple modes. In this regard, in some instances, it may be desirable to adapt the device to provide a more restricted zone of freedom for the child. One particular instance is when the child is seated within a shopping cart. A parent may want to secure a child within the shopping cart help the child remain upright and centered within the shopping cart. The conventional child leashes described above are typically not effective in this situation because conventional child leashes are not configured to connect to a structure, such as a shopping cart, to secure the child within that structure. Thus, the parent may be required to carry a separate child restraint to restrict the child within the shopping cart, or a similar item.

Therefore, there is a need in the art for a child restraint that may be used by a parent to create a tether between the parent and the child when the child is crawling/walking, wherein the child restraint is also adaptable for use to secure a child within a shopping cart or a similar structure.

### BRIEF SUMMARY OF THE INVENTION

The present invention specifically addresses and alleviates the above-identified deficiencies in the art. There is provided a shopping cart and walking harness wearable by a child for use in a “walking mode” or a “shopping cart mode.” In the walking mode, a leash may be connected to the harness and the child's parent may hold the leash to remain in contact with the child. The harness may be easily transitioned from the walking mode into the shopping cart mode by disconnecting the leash from the harness and connecting the harness to a shopping cart seat. Thus, the shopping cart and walking harness provides a universal, all-in-one device for use in restraining a child when the child is walking, as well as when the child is in a shopping cart seat. The shopping cart and walking harness advantageously provides a single substitute for conventional child leashes and shopping cart restraints.

According to one embodiment, the shopping cart and walking harness includes a front first panel and a rear second panel. The first panel is connected to the second panel via a pair of securing panels that extend between the first panel and the second panel on opposed sides of the child. The securing panels are attached to respective lateral side portions of the first panel. Each securing panel defines a distal end portion which is advanced through a respective slit formed within the second panel. The distal end portions overlap with each other to attach the securing panels to each other. The harness additionally includes a pair of shoulder straps that extend from the first panel to the second panel. The shoulder straps extend over the shoulders of the child when the harness is worn by the child.

The present invention is best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a front elevational view of a toddler harness and securing device shown in an unwrapped configuration;

FIG. 2 is a rear elevational view of the harness and securing device;

FIG. 3 is a front elevational view of a leash configured to be selectively engageable with a rear panel of the harness and securing device;

FIGS. 4A is a front view of an end portion of the leash including a first fastener coupled to a strap;

FIG. 4B is a front view of a second fastener secured to the rear panel of the harness and securing device;

FIG. 5 is a front, upper perspective view of the harness and securing device shown in a wrapped configuration;

FIG. 6 is a rear, upper perspective view of the harness and securing device shown in the wrapped configuration; and

FIG. 7 is a rear view of the harness and securing device disposed within a shopping cart to secure a toddler within the shopping cart seat.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

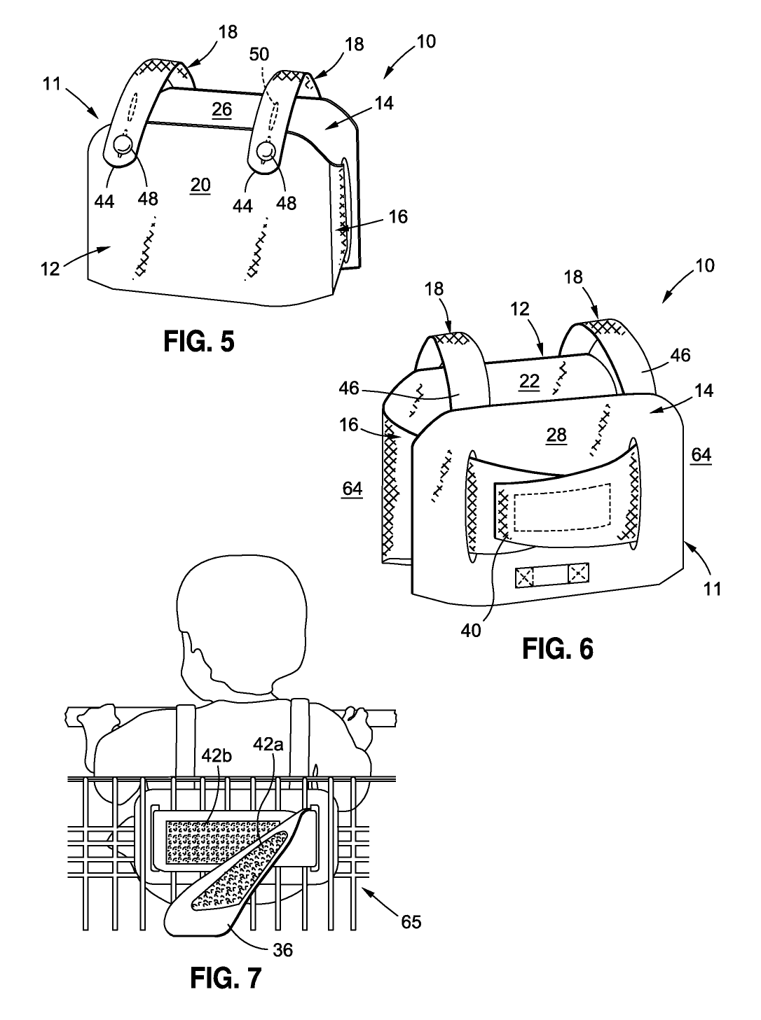

Referring now to the drawings, there is shown a toddler harness and securing device 10 (see FIGS. 5 and 6). The toddler harness and securing device 10 is a universal device which may be used as a child leash when a child is walking, as well as a child restraint to secure the child within a shopping cart seat, or the like. The harness and securing device 10 advantageously combines the functionality of conventional child leashes and shopping cart restraints into an all-in-one device. Therefore, parents no longer need to carry a separate child leash and shopping cart restraint; parents may use the toddler harness and securing device 10 as a single substitute. Furthermore, the toddler harness and securing device 10 is configured to comfortably fit on the child, as well as to provide an aesthetically pleasing design to the child, which makes it more likely that the child will have a desire to wear the device 10.

The toddler harness and securing device 10 generally includes a torso wrap 11 (see FIG. 5) having a first panel 12, a second panel 14, a pair of securing panels 16, and a pair of shoulder straps 18. The first panel 12 and the pair of securing panels 16 define a first wrap member 13 and the second panel 14 defines a second wrap member 15 selectively connectable to the first wrap member 13, as will be described in more detail below. When the device 10 is worn by a child, the first panel 12 is typically disposed over a child's front-side, the second panel 14 is typically disposed over the child's back-side, the securing panels 16 are advanced or extended around the child's sides, and the shoulder straps 18 extend over the child's shoulders. The device 10 is adjustable to adapt the size of the device 10 to the particular size of the child wearing the device 10.

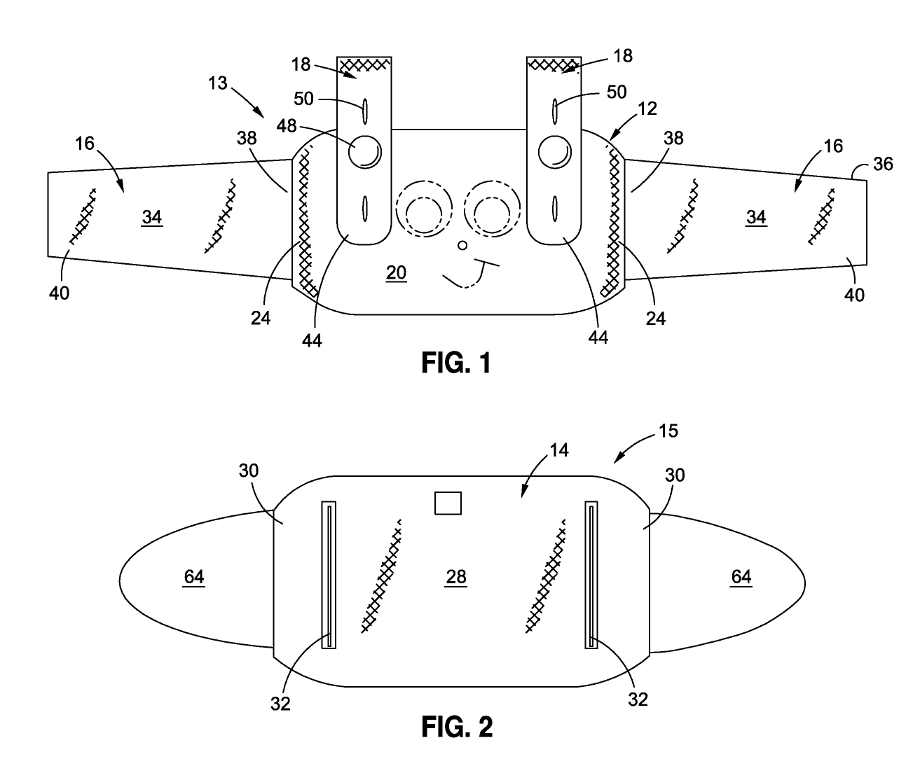

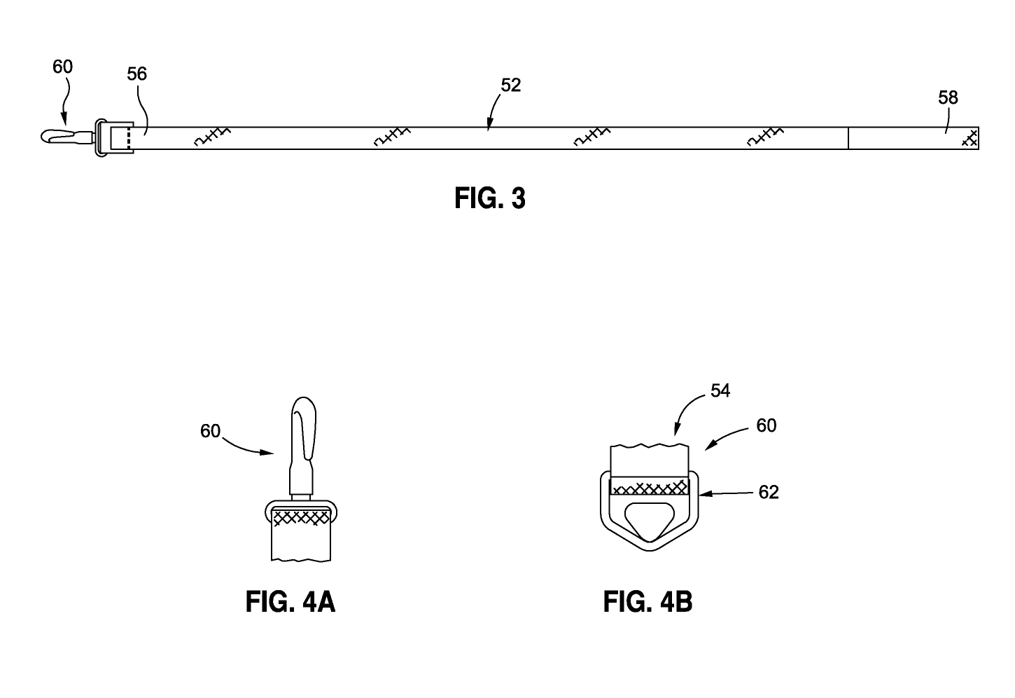

The first panel 12 includes a front first face 20 (see FIGS. 1 and 5), an opposing rear second face 22 (see FIG. 6), and a pair of opposed lateral portions 24 (see FIG. 1). The first face 20 on the toddler harness and securing device 10 may make the device 10 fun for the child to wear.

Turning now to FIG. 2, the second panel 14 includes a front first face 26, an opposing rear second face 28 (See FIG. 6), and a pair of opposed lateral portions 30. A pair of slits 32 is formed within second panel 14, with each slit 32 extending completely through the second panel 14 between the first face 26 and the second face 28. The slits 32 may define a longitudinal dimension that is preferably transverse to the longitudinal dimension of the second panel 14. The second panel 14 may be formed of a padded material to provide a comfortable rear surface when the device 10 is worn by a child seated in a shopping cart, or another chair. For instance, the second panel 14 may be disposed between the child's back and the seat-back to provide a padded layer between the child and the seat.

Referring back now to FIG. 1, each securing panel 16 includes a first face 34, an opposing second face 36, a proximal end portion 38 and a distal end portion 40. The proximal end portion 38 of each securing panel 16 is secured to a respective lateral portion 24 of the first panel 12. The securing panels 16 are preferably sewn to the first panel 12, although other securing techniques known by those skilled in the art, such as welding, adhesives, etc. may be used without departing from the spirit and scope of the present invention. The distal end portions 40 are configured to be advanced through a respective slit 32 formed within the second panel 14. The securing panels 16 are also configured to secure to each other. The securing panels 16 connect the first panel 12 to the second panel 14 when the securing panels 16 are advanced through the slits 32 and connected to each other. Along these lines, the securing panels 16 may include cooperative mechanical fasteners 42a, 42b that engage with each other when the distal end portions 40 overlap each other. For instance, the first face 34 of one securing panel 16 may include a fastener 42b and the second face 36 of the other securing panel 16 may include a complimentary fastener 42a such that when the first face 34 of one securing panel 16 is overlapped on the second face 36 of the other securing panel 16, the fasteners 42a, 42b are brought into engageable alignment with each other. The fasteners 42a, 42b may be configured to accommodate varying degrees of overlap of the distal end portions 40 of the securing panels 16. For instance, when the device 10 is worn on a smaller child, there may be more overlap than when the device 10 is worn on a larger child. Exemplary mechanical fasteners 42a, 42b include hook and loop material, snap fasteners, buttons/slots, magnets, or other mechanical fasteners known by those skilled in the art.

The embodiment described above and shown in the figures provides for circumferential adjustment of the assembly defined by the first panel 12, second panel 14 and securing panels 16 by varying the length which the securing panels 16 are advanced through the slits 32, and the corresponding overlap between the distal end portions 40 of the securing panels 16 when the securing panels 16 are connected to each other. However, those skilled in the art will appreciate that other embodiments may enable different circumferential adjustment means, including a drawstring or an elastic band that is biased radially inward. In this regard, the embodiment described above and depicted in the drawings is exemplary in nature only and is not intended to limit the scope of the present invention.

The shoulder straps 18 are connected to the second panel 14 and are configured to extend over the shoulders of the child wearing the device 10 and engage with the first panel 12. Each shoulder strap 16 includes a first end portion 44 and an opposing second end portion 46. The second end portion 46 is sewn, or otherwise connected with the second panel 14, and the first end portion 44 is configured to engage with fasteners 48 connected to the first panel 12. The embodiment depicted in the Figures includes buttons 48 connected to the first panel 12 which engage with slots 50 formed within the shoulder straps 18. There are several slots 50 formed within the shoulder straps 18 to allow for adjustment of the shoulder straps 18 relative to the first panel 12. Other mechanical fasteners, such as snaps, magnets, hook and loop material, or other mechanical fasteners may be used without departing from the spirit and scope of the present invention.

The first panel 12, second panel 14, securing panels 16, and shoulder straps 18 may be formed from a thin, comfortable material, such as cotton or other materials known in the art. That material is preferably machine washable to accommodate regular washing of the device 10. It is also contemplated that other embodiments may be formed from a plastic material to allow the device 10 to be easily wiped to clean any inadvertent spills. Furthermore, the device 10 may be configured to allow the device 10 to be folded or rolled up when the device 10 is not be used to easily store the device 10.

The device 10 additionally includes a leash 52 and fastening hardware 54 for selectively connecting the leash 52 to the harness. The leash 52 may be connected to the harness for use in the walking mode, i.e., when the child is walking. The leash 52 may be easily disconnected from the harness to adapt the harness for use in the seating/shopping cart mode.

The leash 52 includes a child end portion 56 and an opposing parent end portion 58. The fastening hardware 54 includes a leash portion 60 connected to the child end portion 56 of the leash 52 and a corresponding harness portion 62 coupled to the harness 10, preferably the second panel 14 of the harness 10.

Certain embodiments of the device includes aesthetic wings 64 connected to the second panel 28 to enhance the look and appearance of the device 10. The combination of the cartoon or animal design on the fist panel 12 and the wings 64 connected to the second panel 28 makes the device 10 more appealing to the child, and ultimately, more fun to wear. The size and shape of the wings 64 may be varied to correspond to the cartoon or animal design depicted on the first panel 12.

With the structural features of the device 10 set forth above, the following discussion focuses on usage of the device 10. In the walking mode, the harness is placed on the child by connecting the shoulder straps 18 to the first panel 12, which in turn, connects the first panel 12 to the second panel 14. The device 10 is draped over the child's head, with the shoulder straps 18 extending over respective ones of the child's shoulders and with the first panel 12 disposed over the child's front-side (chest/stomach) and the second panel 14 disposed over the child's back-side (shoulders/back). The shoulder straps 18 may be adjusted to properly size the device 10 once it is draped over the child.

The securing panels 16 are then wrapped around the child's sides and the distal end portions 40 of the securing panels 16 are advanced through corresponding ones of the slits 32 formed within the second panel 14. The securing panels 16 are pulled to tighten the device 10 around the child. The securing panels 16 are then connected to each other to secure the device 10 to the child. The securing panels 16 may also be adjusted to conform the device 10 to the particular size of the child.

Although the foregoing describes the steps of connecting the shoulder straps 18 before the securing panel 16 are connected, it is understood that the securing panels 16 may be connected before the shoulder straps 18 are connected.

When used in the walking mode, the leash 52 is connected to the second panel 14 by connecting the leash portion 60 to the harness portion 62. The parent may then hold the parent end portion 58 of the leash 52 to remain tethered to the child. The leash 52 defines a zone around the parent within which the child may move about. However, the leash 52 prevents the child from walking outside of the defined zone.

To adapt the device 10 from the walking mode into the seating/shopping cart mode, the leash 52 is disconnected from the second panel 14 by disconnecting the leash portion 60 of the hardware 54 from the harness portion 62. The securing panels 16 are then disconnected to allow the distal end portions 40 to pass through those bars of the shopping cart 65 which define the backrest portion of the child seat thereof. The securing panels 16 are then re-secured to each other, the bars of the shopping cart thus being captured between the securing panels 16 and the second panel 14 which effectively pads the child back against such bars. Thus, when the securing panels 16 are engaged to each other, the device 10 is secured to the shopping cart and therefore safely restrains the child in a centered an upright position within the shopping cart seat.

When the device 10 is initially used in the shopping cart mode i.e., not adapted from the walking mode, the device 10 is placed on the child in the same manner as described above, however, the securing panels 16 are advanced through the shopping cart bars before the securing panels 16 are connected to each other.

Although the foregoing describes usage of the device 10 in the shopping cart mode in connection with a shopping cart, it is understood that the device 10 may be used with other seats or chairs to position the child in a centered and upright position on the chair. Along these lines, the adjustable capability provided by the securing panels 16 allows the device 10 to be used in seats, chairs or shopping carts that vary in size and configuration.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A convertible walking harness/seating restraint device positionable on a toddler an configured for use with a seat, the device comprising:
a torso wrap extensible around the toddler's torso, the torso wrap having a front portion positionable adjacent the toddler's chest, a pair of side portions positionable under the toddler's arms, and a back portion positionable adjacent the toddler's back, the torso wrap being adjustable to adapt to the size of the toddler and being connectable to the seat to restrain the child thereto;
a pair of shoulder straps extending from the front portion of the torso wrap to the back portion of the torso wrap and positionable adjacent respective ones of the toddler's shoulders; and
a leash selectively connectable to the torso wrap;
wherein the convertible device is transitional from a seating configuration wherein the torso wrap is connected to the seat and the leash is disconnected from the torso wrap, and a harness configuration wherein the torso wrap is disconnected from the seat and the leash is connected to the torso wrap.

2. The convertible device recited in claim 1, wherein the torso wrap includes a first wrap member and a second wrap member selectively engageable with the first wrap member.

3. The convertible device recited in claim 2, wherein the first wrap member includes a first panel and a pair of side panels connected to the first panel, and the second wrap member includes a rear panel, the pair of side panels being selectively engageable with the rear panel.

4. The convertible device recited in claim 3, wherein the pair of side panels are connectable to each other to connect the torso wrap to the toddler.

5. The convertible device recited in claim 4, wherein the pair of side panels are connectable to each other in overlapping fashion, the degree of overlap being adjustable to adjust the size of the torso wrap on the toddler.

6. The convertible device recited in claim 5, wherein the pair of side panels are engageable with the seat to connect the device to the seat when the convertible device is in the seating configuration.

7. The convertible device recited in claim 3, wherein the rear panel includes a pair of slots configured to receive a respective one of the pair of side panels.

8. The convertible device recited in claim 1, further including a pair of fasteners, each fastener being configured to connect an end portion of a respective one of the pair of shoulder straps to the torso wrap.

9. The convertible device recited in claim 8, wherein the pair of fasteners includes a pair of buttons, each shoulder strap including a slot configured to receive a respective one of the pair of buttons.

10. The convertible device recited in claim 1, further comprising a pair of aesthetic wings connected to and extending from the torso wrap.

11. A convertible walking harness/seating restraint device positionable on a toddler an configured for use with a seat, the device comprising:
a torso wrap extensible around the toddler's torso, the torso wrap having a front portion positionable adjacent the toddler's chest, a pair of side portions positionable under the toddler's arms, and a back portion positionable adjacent the toddler's back, the torso wrap being adjustable to adapt to the size of the toddler and being connectable to the seat to restrain the child thereto; and
a leash selectively connectable to the torso wrap;
wherein the convertible device is transitional from a seating configuration wherein the torso wrap is connected to the seat and the leash is disconnected from the torso wrap, and a harness configuration wherein the torso wrap is disconnected from the seat and the leash is connected to the torso wrap.

12. The convertible device recited in claim 11, wherein the torso wrap includes a first wrap member and a second wrap member selectively engageable with the first wrap member.

13. The convertible device recited in claim 12, wherein the first wrap member includes a first panel and a pair of side panels connected to the first panel, and the second wrap member includes a rear panel, the pair of side panels being selectively engageable with the rear panel.

14. The convertible device recited in claim 13, wherein the pair of side panels are connectable to each other to connect the torso wrap to the toddler.

15. The convertible device recited in claim 14, wherein the pair of side panels are connectable to each other in overlapping fashion, the degree of overlap being adjustable to adjust the size of the torso wrap on the toddler.

16. The convertible device recited in claim 15, wherein the pair of side panels are engageable with the seat to connect the device to the seat when the convertible device is in the seating configuration.

17. The convertible device recited in claim 13, wherein the rear panel includes a pair of slots configured to receive a respective one of the pair of side panels.

18. The convertible device recited in claim 11, further comprising a pair of aesthetic wings connected to and extending from the torso wrap.

19. A convertible walking harness/seating restraint device positionable on a toddler an configured for use with a seat, the device comprising:
a first wrap member having a front panel positionable adjacent the toddler's chest and a pair of securing panels connected to the front panel;
a second wrap member having a back panel positionable adjacent the toddler's back, the second wrap member having a pair of slots formed within the back panel, the pair of securing panels being advanceable through respective ones of the pair of slots to connect the first wrap member to the second wrap member, the first and second wrap members being collectively connectable to the seat to restrain the child thereto;
a pair of shoulder straps extending from the first wrap member to the second wrap member and positionable adjacent respective ones of the toddler's shoulders; and
a leash selectively connectable to the second wrap member;
wherein the convertible device is transitional from a seating configuration wherein the first and second wrap members are connected to the seat and the leash is disconnected from the second wrap member, and a harness configuration wherein the first and second wrap members are disconnected from the seat and the leash is connected to the second wrap member.

20. The convertible device recited in claim 19, wherein the pair of securing panels are connectable to each other in overlapping fashion, the degree of overlap being adjustable to adjust the size of the first and second wrap members on the toddler.
